(19) United States
(12) Patent Application Publication
(10) Pub. No.: US 2010/0002334 A1
(43) Pub. Date: Jan. 7, 2010

(54) SPINDLE SYSTEM, ELECTROMAGNETIC CONVERSION PROPERTY EVALUATING APPARATUS AND INFORMATION STORAGE DEVICE

(75) Inventor: Yoshinobu Kawata, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/409,130

(22) Filed: Mar. 23, 2009

(30) Foreign Application Priority Data
Jul. 4, 2008 (JP) 2008-175783

(51) Int. Cl. G11B 17/08

(52) U.S. Cl. 360/98.07; G9B/17.041

(57) ABSTRACT

A spindle system includes: a spindle motor section controlled to rotate at a predetermined speed; and a clamp base section disposed at an upper part of the spindle motor section and having screw holes that are formed in a side surface of the clamp base section and extend in a radial direction. The spindle system further includes: screws respectively inserted into the screw holes and changing a center of gravity of the clamp base section; a clamp fixing section that fixes the spindle motor section and the clamp base section; and an elastic member disposed between the clamp base section and the clamp fixing section, and contacted by and pressed against the screws.

### CROSS-REFERENCE TO RELATED APPLICATION

This application is based upon and claims the benefit of priority of the prior Japanese Patent Application No. 2008-175783, filed on Jul. 4, 2008, the entire contents of which are incorporated herein by reference.

### FIELD

The embodiment discussed herein is related to a spindle system provided with a balance adjustment mechanism, and an electromagnetic conversion property evaluating apparatus as well as an information storage device provided with the spindle system.

### BACKGROUND

As an information storage device that stores information, a hard disk drive (HDD) is widely used for computers and the like.

An HDD includes a hard disk (HD) in the shape of a circular plate. The rotation of the HD is controlled by a spindle motor. The HDD also includes a magnetic head. When being placed at a position in extremely close proximity to a surface of the HDD, the magnetic head records information on the HDD or reads information recorded on the HD.

Here, as one of test devices used in manufacturing an HDD, there is used an electromagnetic conversion property evaluating apparatus that evaluates the electromagnetic conversion property of a magnetic head.

FIG. 1 is a schematic diagram of an electromagnetic conversion property evaluating apparatus 1.

The electromagnetic conversion property evaluating apparatus 1 includes: a spindle system section 10, an HD 20, and an analyzer 30. The HD 20 is fixed to the spindle system section 10, and the rotation of the HD 20 is controlled by a spindle motor. When a magnetic head 2 targeted for a test is placed in the proximity of the HD 20, the magnetic head 2 accesses the HD 20 (i.e., reads information from or records information on the HD 20). The results of the access are analyzed by the analyzer 30, so that the electromagnetic conversion property of the magnetic head 2 is evaluated.

In order to accurately evaluate the property of the magnetic head 2 by using the electromagnetic conversion property evaluating apparatus 1, the HD 20 needs to be precisely and smoothly rotated. Further, it is necessary to readily replace the HD 20 upon occurrence of deterioration or failure of the HD 20. In these respects, the structure of the spindle system section 10 is important.

Since the structure of the spindle system section 10 is important, a conventional example of the spindle system region 10 will be described first.

FIG. 2 is a perspective diagram of a conventional spindle system section 10A and an HD 20 accommodated in a shell 40, in a state in which a lid 42 of the shell 40 is open. FIG. 3 is an enlarged perspective diagram of the spindle system section 10A illustrated in FIG. 2. FIG. 4 is an exploded perspective diagram of the spindle system section 10A illustrated in FIG. 2 and FIG. 3.

The spindle system section 10A (corresponding to the spindle system section 10 illustrated in FIG. 1) and the HD 20 are disposed on a base section 41 of the shell 40, and covered with the lid 42 connected via a hinge to the base section 41.

As illustrated in FIG. 4, a spindle motor 110 is inserted into a central hole 21 of the HD 20, and a clamp base 111 is disposed on and fixed to the spindle motor 110 by means of screw. In a concave portion 111a of the clamp base 111, guiding bases 112 are disposed. Here, three guiding bases 112 are employed. Disposed in a central area surrounded by the three guiding bases 112 is a clamp base cover 113, and a rotary scale 114 is disposed on the clamp base cover 113. The rotary scale 114 is a scale for detecting a rotation angle of the spindle motor 110.

Here, a hole extending in the direction of the radius of rotation is formed in each of the guiding bases 112. A cap stopper 112a is disposed to outwardly project from the hole, while a spring 112b is disposed to inwardly project from the hole. The spring 112b is inserted into a hole 113a of the clamp base cover 113, thereby pressing the cap stopper 112a outwardly.

The spindle system section 10A is provided with a hollow cylindrical cap 115. When the cap 115 is put on, the cap stoppers 112a are pressed against an inner wall surface of the cap 115, thereby preventing unintentional removal of the cap 115.

When necessary however, it is possible to readily remove the cap 115 by lifting the cap 115. The HD 20 can also be readily removed for replacement in a state in which the cap 115 is removed.

In recent years, since HDs have become finer and larger incapacity, magnetic heads have also become finer. Therefore, in a state in which the balance of rotation of an HD is not corrected, it is impossible to accurately evaluate a magnetic head. As a result, a large number of magnetic heads are determined as defective, thereby largely affecting yields. In order to deal with such a tendency, it is conceivable to provide a spindle system with a balance adjustment mechanism. As a typical balance adjustment mechanism, there is proposed a structure in which screw holes are formed in the outer surface of a brim of a rotation tool, and screws for adjusting the balance are inserted into the screw holes (see, for example, Japanese Laid-open Utility Model Publication No. 05-53839 and Japanese Laid-open Patent Publication No. 2001-129743). The mechanisms per se proposed in these publications are effective in terms of balance adjustment, but they have such a drawback that it is difficult to prevent loosening of the screws because the spindle motor runs at a high speed.

In order to prevent loosening of the screws, it is conceivable to fix the screws after the adjustment with an adhesive so that the screws cannot move. However, when the electromagnetic conversion property evaluating apparatus 1 as illustrated in FIG. 1 is employed, it is necessary to replace the HD 20 and to carry out readjustment every time the HD is replaced and therefore, it is not practical to fix the screws with an adhesive.

### SUMMARY

According to an aspect of the invention, a spindle system includes:

a spindle motor section controlled to rotate at a predetermined speed;

a clamp base section disposed at an upper part of the spindle motor section and having a plurality of screw holes that are formed in a side surface of the clamp base section and extend in a radial direction;

a plurality of screws respectively inserted into the screw holes and changing a center of gravity of the clamp base section;

a clamp fixing section that fixes the spindle motor section and the clamp base section; and

an elastic member disposed between the clamp base section and the clamp fixing section, and contacted by and pressed against the screws.

According to another aspect of the invention, an electromagnetic conversion property evaluating apparatus includes:

a spindle system including:
a spindle motor section controlled to rotate at a predetermined speed,
a clamp base section disposed at an upper part of the spindle motor section and having a plurality of screw holes that are formed in a side surface of the clamp base section and extend in a radial direction,
a plurality of screws respectively inserted into the screw holes and changing a center of gravity of the clamp base section,
a clamp fixing section that fixes the spindle motor section and the clamp base section, and
an elastic member disposed between the clamp base section and the clamp fixing section, and contacted by and pressed against the screws;

a storage medium restrained by the spindle system; and

an analyzer that analyzes an electromagnetic conversion property of a magnetic head that includes a reproducing element for reproducing information from the storage medium and a recording element for recording information into the storage medium.

According to yet another aspect of the invention, an information storage device includes:

a spindle system including:
a spindle motor section controlled to rotate at a predetermined speed,
a clamp base section disposed at an upper part of the spindle motor section and having a plurality of screw holes that are formed in a side surface of the clamp base section and extend in a radial direction,
a plurality of screws respectively inserted into the screw holes and changing a center of gravity of the clamp base section,
a clamp fixing section that fixes the spindle motor section and the clamp base section, and
an elastic member disposed between the clamp base section and the clamp fixing section, and contacted by and pressed against the screws;

a storage medium restrained by the spindle system;

a magnetic head that includes a reproducing element for reproducing information from the storage medium and a recording element for recording information into the storage medium; and

a signal processing board used for processing a reproduction signal that represents information reproduced from the storage medium by the magnetic head and a recording signal that represents information recorded into the storage medium by the magnetic head.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a schematic diagram of an electromagnetic conversion property evaluating apparatus;

FIG. 2 is a perspective diagram of a conventional spindle system section and an HD accommodated in a shell, in a state in which a lid of the shell is open;

FIG. 3 is an enlarged perspective diagram of the spindle system section illustrated in FIG. 2;

FIG. 4 is an exploded perspective diagram of the spindle system section illustrated in FIG. 2 and FIG. 3;

FIG. 5 is a perspective diagram of a spindle system section and an HD accommodated in a shell, in a state in which a lid of the shell is open, according to an embodiment;

FIG. 6 is an enlarged perspective diagram of the spindle system section illustrated in FIG. 5;

FIG. 7 is an exploded perspective diagram of the spindle system section illustrated in FIG. 5 and FIG. 6;

FIG. 8 is a perspective diagram of a screw for balance adjustment;

FIG. 9 is a perspective diagram of a clamp spring that presses the screw for balance adjustment;

FIG. 10 is a diagram that illustrates an operational method for adjusting the balance of the spindle system in the present embodiment;

FIGS. 11A and 11B illustrate a flow chart of an example of a balance adjustment method; and

FIG. 12 is a diagram that illustrates an HDD according to the present embodiment.

### DESCRIPTION OF EMBODIMENT(S)

An embodiment will be described below.

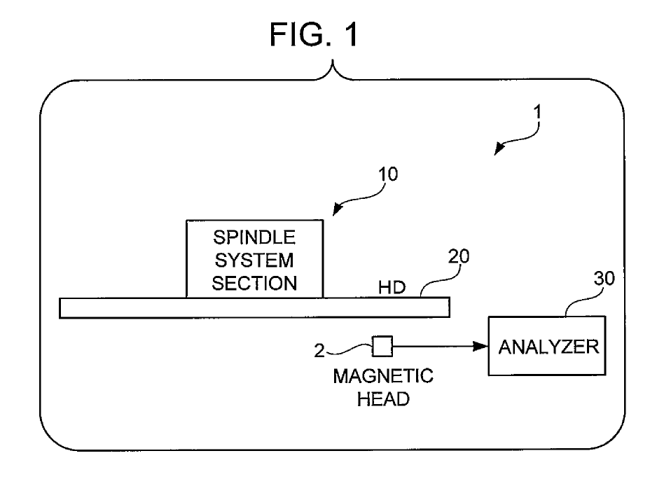

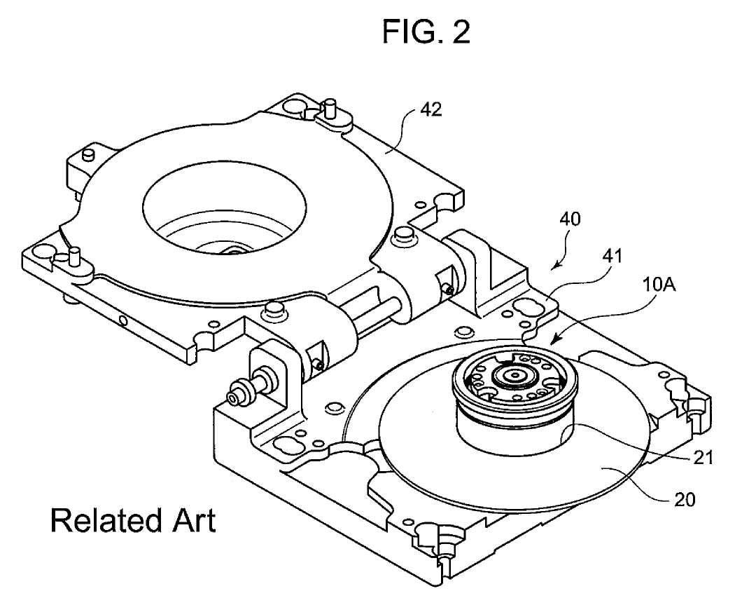

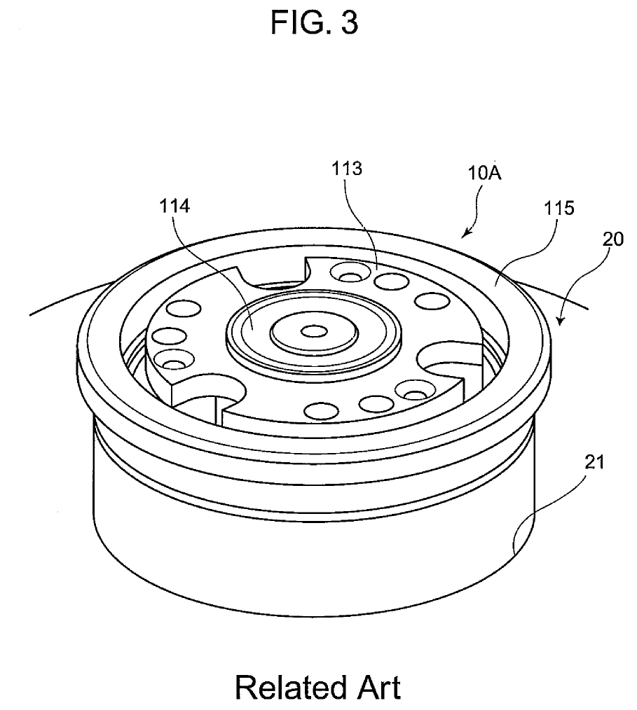

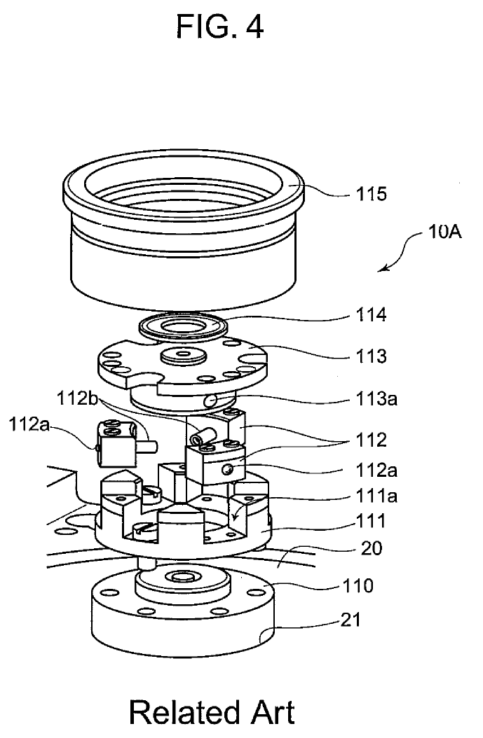

The entire conceptual diagram of the electromagnetic conversion property evaluating apparatus illustrated in FIG. 1 can be utilized as it is in the present embodiment. Therefore, FIG. 1 is used as a block diagram of an electromagnetic conversion property evaluating apparatus according to the present embodiment.

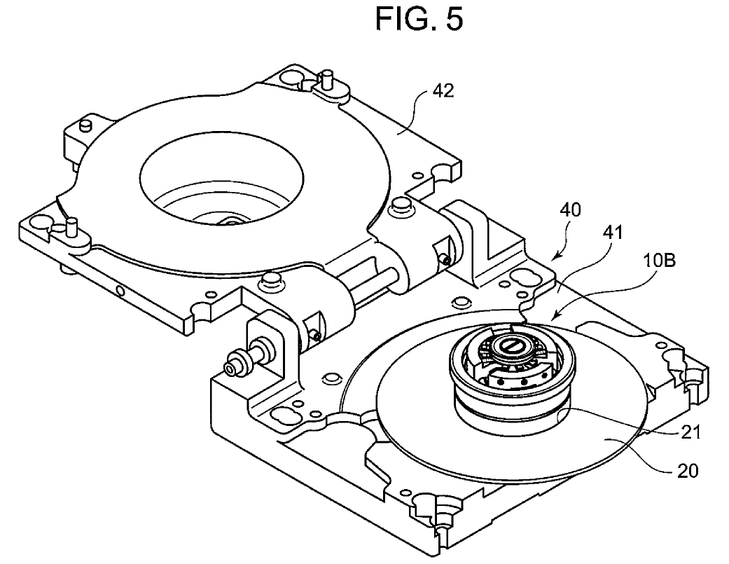

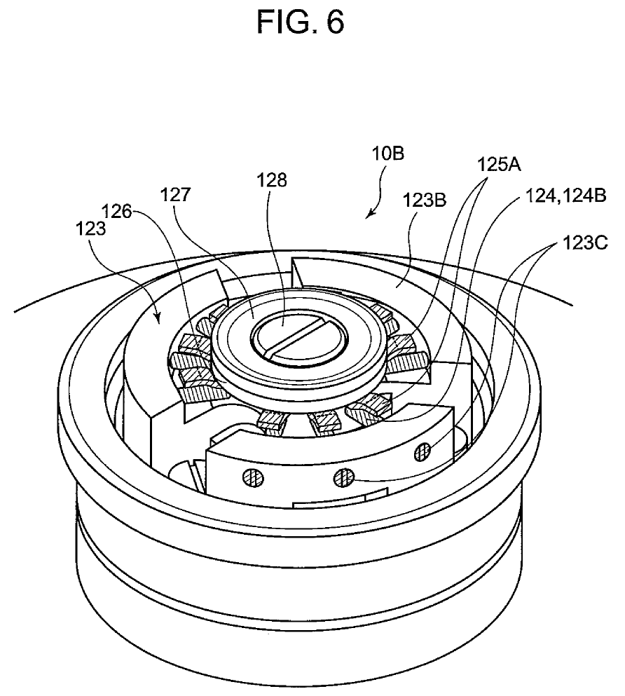

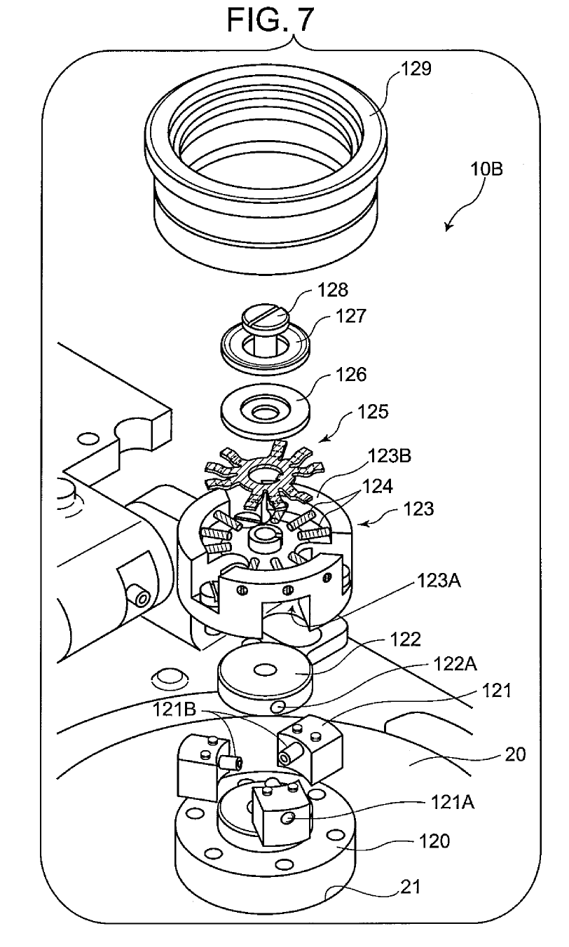

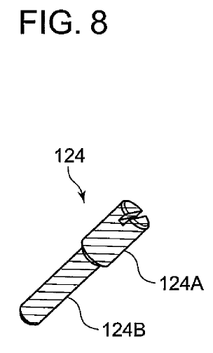

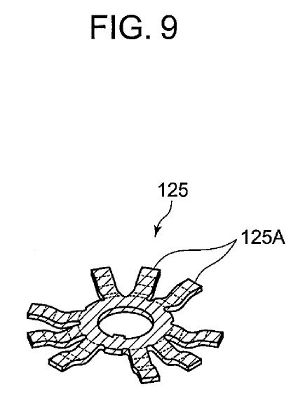

FIG. 5 is a perspective diagram of a spindle system section 10B and an HD 20 accommodated in a shell 40, in a state in which a lid 42 of the shell 40 is open, according to the present embodiment. FIG. 6 is an enlarged perspective diagram of the spindle system section 10B illustrated in FIG. 5. FIG. 7 is an exploded perspective diagram of the spindle system section 10B illustrated in FIG. 5 and FIG. 6. Further, FIG. 8 is a perspective diagram of a screw 24 for balance adjustment, and FIG. 9 is a perspective diagram of a clamp spring 125 that presses the screw 124 for balance adjustment.

The spindle system section 10B (corresponding to the spindle system section 10 illustrated in FIG. 1) and the HD 20 are disposed on a base section 41 of the shell 40, and covered with the lid 42 connected via a hinge to the base section 41 when the lid 42 is closed.

As illustrated in FIG. 7, a spindle motor 120 is inserted into a central hole 21 of the HD 20. Disposed on the spindle motor 120 is a block including guiding bases 121, a clamp guide 122 and a clamp base 123. In each of the guiding bases 121 of the block, a hole extending in the radial direction of rotation of the HD 20 is formed. A cap stopper 121A is disposed to project outwardly from the hole, while a spring 121B is disposed to project inwardly from the hole. Here, three guiding bases 121 are provided, and the clamp guide 122 is disposed in a central area surrounded by the three guiding bases 121. The spring 121B of the guiding base 121 is inserted into a hole 122A of the clamp guide 122. The guiding base 121 is inserted from below into a downwardly open concave 123A of the clamp base 123 and fixed to the clamp base 123 by means of screw. The clamp base 123 combined with the guiding bases 121 and the clamp guide 122 is fixed on the spindle motor 120 by means of screw.

Formed at an upper part of the clamp base 123 is a wall 123B in the form of a circular arc, standing to surround a central area of the clamp base 123. In a side of the wall 123B, nine screw holes 123C extending in the radial direction while aligning in the circumferential direction are formed. Into each of these screw holes 123C, a male-threaded tap portion 124A of the screw 124 as illustrated in FIG. 8 is inserted. The screw 124 illustrated in FIG. 8 includes a shaft portion 124B which has no screw threads at a tip and whose diameter is shorter than the diameter of the tap portion 124A. Inside the wall 123B, the shaft portion 124B rests on a top surface of the clamp base 123 and supported by the clamp base 123.

On the clamp base 123, a clamp spring 125 having a shape illustrated in FIG. 9 is disposed. The clamp spring 123 is a ring-shaped member having a hole in the center. The clamp spring 123 has nine arm sections 125A extending radially and aligned at the same pitches in the circumferential direction as those of the screws 124 represented by the one illustrated in FIG. 8.

Disposed on the clamp spring 125 is a clamp cover 126, and a rotary scale 127 is fixed on the top surface of the clamp cover 126 with adhesion. The rotary scale 127 is a scale for detecting a rotation angle of the spindle motor 120. A groove (not illustrated) is formed in the clamp cover 126, allowing the clamp cover 126 to be engaged with the clamp base 123 in a non-rotatable manner, thereby determining the position of the clamp cover 126 in the rotation direction relative to the clamp base 123. Thanks to this structure, it is possible to ensure the reproducibility of a position of the rotary scale 127 (fixed to the clamp cover 126 with adhesion) in the rotation direction, at the time when the clamp cover 126 is once removed and attached again.

In a state in which the clamp spring 125 is disposed on the clamp base 123 and further, the clamp cover 126 to which the rotary scale 127 is adhered is disposed on the clamp spring 125, both of the clamp spring 125 and the clamp cover 126 with the rotary scale 127 are fixed to the clamp base 123 by means of screw. As a result, each of the arm sections 125A of the clamp spring 125 presses the shaft portion 124B of the corresponding screw 124 from above, so that the shaft portion 124B is secured while being pressed against the top surface of the clamp base 123.

Subsequently, a cylindrical cap 129 is put on from above. The cap stopper 121A is pressed against an inner wall surface of the cap 129, thereby preventing unintentional removal of the cap 129. Further, the height of the top surface of the cap 129 is lower than the position where the screw hole 123C is formed in the wall 123B of the clamp base 123, so that the screw 124 can be turned and the position of the screw 124 can be moved radially, even when the cap 129 is put on.

Furthermore, the cap 129 can be easily removed by being lifted, so that the HD 20 can be readily replaced after the cap 129 is removed.

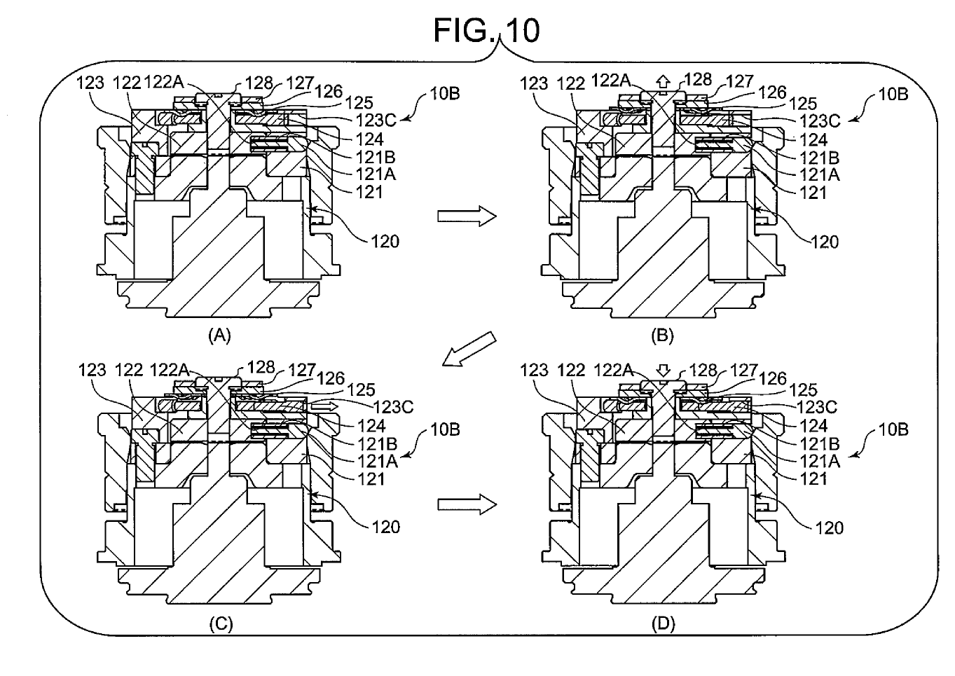

FIG. 10 is a diagram that illustrates an operational method for adjusting the balance of the spindle system in the present embodiment.

Part (A) of FIG. 10 illustrates a state before a balance adjustment is made. When the clamp screw 128 is tightened, the screw 124 for adjusting the balance is elastically contacted by and pressed against the clamp base 123 by means of the clamp spring 125, thereby making it possible to prevent losing of the balance due to loosening of the screw 124 even when the spindle system section 10B is rotated at a high speed.

In order to adjust the balance, first, the clamp screw 128 is loosened as illustrated in part (B) of FIG. 10. As a result, the pressing force applied by the clamp spring 125 to the screw 124 for adjusting the balance is reduced. Next, in this state, the screw 124 is turned to move radially as illustrated in part (C) of FIG. 10. Subsequently, as illustrated in part (D) of FIG. 10, the clamp screw 128 is tightened again. This series of processes depicted in part (A) through part (D) of FIG. 10 is repeated when the balance is adjusted further.

Here, there will be introduced an example of the balance adjustment method for the spindle system of the present embodiment described so far.

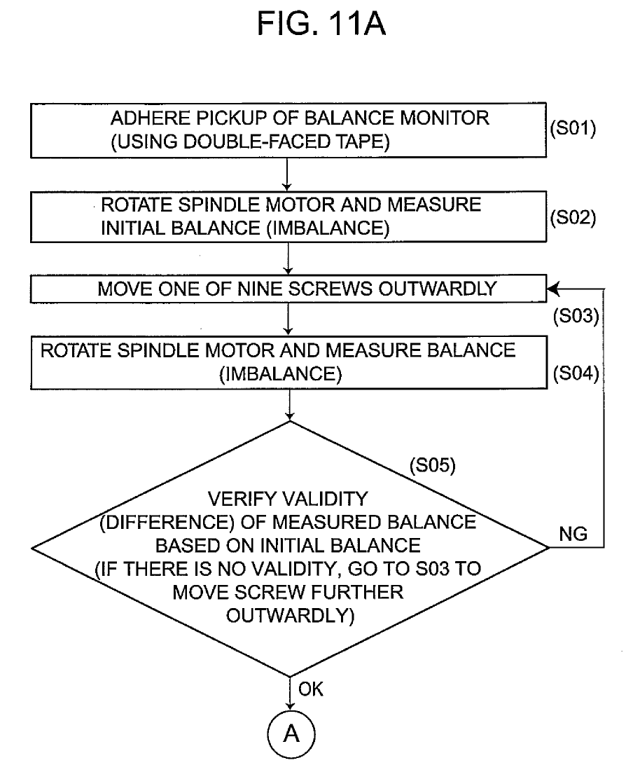

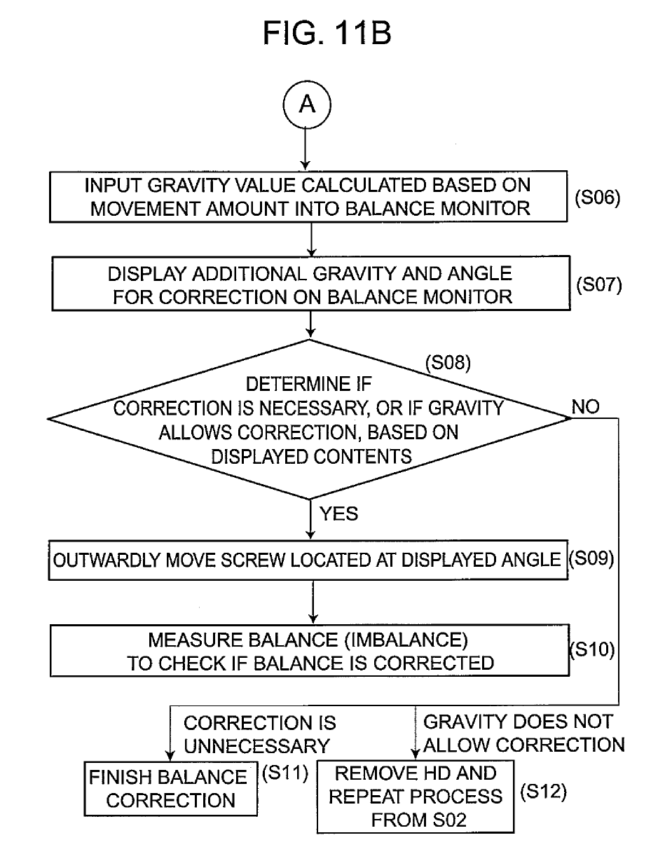

FIGS. 11A and 11B illustrate a flow chart of an example of the balance adjustment method.

At first, a pickup of a balance monitor is adhered (step S01). The pickup is adhered with a double-faced tape, because it is desirable for the HD 20 and the magnetic head for accessing the HD 20 to avoid magnetic field environment since the HD 20 and the magnetic head are used for magnetically recording and reading information. Here, for example, a product named SB-8800R-C made by Sigma Electronics Co., Ltd. can be used as the balance monitor. The pickup of the balance monitor is a sensor for detecting the vibration of a member to which the pickup is adhered. For instance, in a state in which the lid 42 of the shell 40 illustrated in FIG. 5 is closed, two pickups in total are respectively adhered at two positions of the shell 40. These two positions are different in phase by 90 degrees in the rotation direction of the spindle system 10B.

Subsequently, the spindle motor 120 is rotated, and the initial balance/imbalance (angle and amount of displacement) is measured (step S02).

Next, only one of the nine screws 124 (see FIG. 6-FIG. 8 and FIG. 10) radially arranged is moved outward (step S03).

In this step, as described above with reference to part (A) through part (D) of FIG. 10, first, the clamp screw 128 is loosened; subsequently, one of the nine screws 124 is turned to move outward; and finally, the clamp screw 128 is tightened again. Here, the angle of the rotation direction of the screw 124 outwardly moved is defined as zero degree.

Subsequently, the spindle motor 120 is rotated again, and balance/imbalance is measured (step S04). Here, whether or not there is validity of the measured balance in comparison with the initial balance (obtained in step S02) is verified. In other words, whether or not there is a significant difference between the balance measured here and the initial balance is determined. When there is no validity, namely, when there is no sufficient significant difference with respect to the initial balance, it is impossible to perform a computation for adjusting the balance with sufficient accuracy. Accordingly, the screw 124 moved in step S03 is further moved outward (step S05), and balance/imbalance is measured again in step S04.

When it is determined that there is validity, the flow proceeds to step S06, in which a value corresponding to gravity calculated based on the amount of movement of the screw 124 moved in step S03 is input into the balance monitor.

Subsequently, a computation is performed in the balance monitor, and information about additional gravity required for correcting the balance and an angle where the additional gravity needs to be added is displayed on a display screen of the balance monitor (step S07).

In step S08, by looking at the displayed contents, an operator determines whether or not correction is necessary, and also determines whether or not the gravity allows correction when the correction is necessary. Whether or not the gravity allows correction is determined based on whether it is possible to make a balance adjustment within a range in which one of the nine screws 124 positioned at the angle where the gravity needs to be added can be radially moved to the maximum.

When it is determined that correction is not necessary, the process for the balance correction ends (step S11). When it is determined that the gravity does not allow correction, the HD 20 is once removed and then attached again and subsequently, the balance adjustment process starting from step S02 is repeated.

When it is determined that the gravity allows correction in step S08, the flow proceeds to step S09 in which the screw 124 positioned at the angle detected in step S07 is moved outward. Here, the sequence of processes described above with reference to part (A) through part (D) of FIG. 10 is performed. The amount of movement of the screw 124 moved here is the amount of movement calculated based on the additional gravity displayed on the balance monitor.

Subsequently, balance/imbalance is measured again to check whether the balance correction is accomplished (step S10). When it is determined by the operator, based on the contents displayed on the balance monitor, that there is no need to correct the balance further, the balance correction process ends (step S11). Meanwhile, when it is determined that the balance correction is not sufficient, the screw 124 is moved again in step S09.

In this way, by performing each of the above-described steps using the balance monitor, it is possible to readily correct the balance of the spindle system according to the present embodiment.

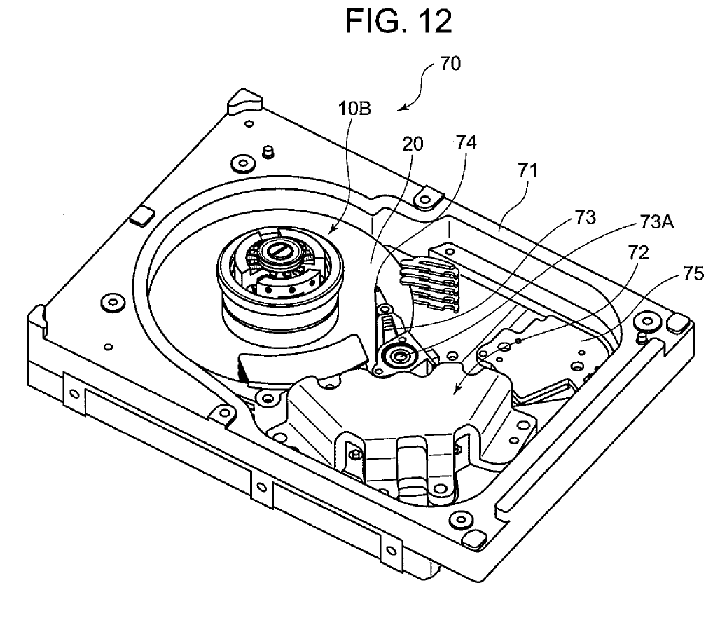

FIG. 12 is a diagram that illustrates an HDD 70 according to the present embodiment.

The HDD 70 includes a housing 71 accommodating the above-described spindle system 10B and HD 20 of the present embodiment. Here, there is provided an arm 73 that rotates when driven by a voice coil motor 72. Also, a magnetic head 74 for accessing the HD 20 is provided at the tip of the arm 73. The arm 73 is driven by the voice coil motor 72 to pivot on a rotation center 73A, thereby moving the magnetic head 74 provided at the tip of the arm 73 to a position above the HD 20 rotating while being driven by the spindle motor.

The HDD 70 further includes a signal processing board 75 used for processing a reproduction signal that represents information reproduced from the HD 20 by the magnetic head 74 and a recording signal that represents information recorded on the HD 20 by the magnetic head 74. The magnetic head 74 accesses the HD 20 under the control of a circuit provided on the signal processing board 75.

The HDD 70 will not be further described, because the structure of the HDD 70 is similar to that of a conventional HDD except that the HDD 70 includes the spindle system 10B with the balance mechanism.

Since the HDD 70 is provided with the spindle system 10B as described above, the HDD 70 can be mounted with the HD 20 that can be rotated in excellent balance while having a smaller track pitch and a higher capacity than those of conventional HDs.

According to the present embodiment and as described above in SUMMARY, each of the spindle system, the electromagnetic conversion property evaluating apparatus, and the information storage device includes the elastic member disposed between the clamp base section and the clamp fixing section, and contacted by and pressed against the screws for adjusting the balance. Because the elastic member in contact with the screws is pressed against the screws, it is possible to prevent loosening due to rotation. In addition, since the contact and pressure between the elastic member and the screws can be reduced by removing the clamp fixing section from the clamp base section or releasing the fastening, it is possible to readily make a readjustment.

According to the present embodiment, it is possible to repeat a balance adjustment while preventing loosening due to rotation.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment of the present invention has been described in detail, it should be understood that the various changes, substitutions, and alterations could be made hereto without departing from the spirit and scope of the invention.

What is claimed is:

1. A spindle system comprising:
a spindle motor section controlled to rotate at a predetermined speed;
a clamp base section disposed at an upper part of the spindle motor section and having a plurality of screw holes that are formed in a side surface of the clamp base section and extend in a radial direction;
a plurality of screws respectively inserted into the screw holes and changing a center of gravity of the clamp base section;
a clamp fixing section that fixes the spindle motor section and the clamp base section; and
an elastic member disposed between the clamp base section and the clamp fixing section, and contacted by and pressed against the screws.

2. The spindle system according to claim 1, wherein each of the screws includes a tap portion and a shaft portion with a diameter smaller than a diameter of the tap portion.

3. The spindle system according to claim 1, wherein the elastic member is a circular flat spring.

4. An electromagnetic conversion property evaluating apparatus comprising:
a spindle system comprising:
a spindle motor section controlled to rotate at a predetermined speed,
a clamp base section disposed at an upper part of the spindle motor section and having a plurality of screw holes that are formed in a side surface of the clamp base section and extend in a radial direction,
a plurality of screws respectively inserted into the screw holes and changing a center of gravity of the clamp base section,
a clamp fixing section that fixes the spindle motor section and the clamp base section, and
an elastic member disposed between the clamp base section and the clamp fixing section, and contacted by and pressed against the screws;
a storage medium restrained by the spindle system; and
an analyzer that analyzes an electromagnetic conversion property of a magnetic head that includes a reproducing element for reproducing information from the storage medium and a recording element for recording information into the storage medium.

5. The electromagnetic conversion property evaluating apparatus according to claim 4, wherein each of the screws includes a tap portion and a shaft portion with a diameter smaller than a diameter of the tap portion.

6. The electromagnetic conversion property evaluating apparatus according to claim 4, wherein the elastic member is a circular flat spring.

7. An information storage device comprising:
a spindle system comprising:
a spindle motor section controlled to rotate at a predetermined speed,
a clamp base section disposed at an upper part of the spindle motor section and having a plurality of screw holes that are formed in a side surface of the clamp base section and extend in a radial direction,
a plurality of screws respectively inserted into the screw holes and changing a center of gravity of the clamp base section,
a clamp fixing section that fixes the spindle motor section and the clamp base section, and
an elastic member disposed between the clamp base section and the clamp fixing section, and contacted by and pressed against the screws;
a storage medium restrained by the spindle system;
a magnetic head that includes a reproducing element for reproducing information from the storage medium and a recording element for recording information into the storage medium; and
a signal processing board used for processing a reproduction signal that represents information reproduced from the storage medium by the magnetic head and a recording signal that represents information recorded into the storage medium by the magnetic head.

8. The information storage device according to claim 7, wherein each of the screws includes a tap portion and a shaft portion with a diameter smaller than a diameter of the tap portion.

9. The information storage device according to claim 7, wherein the elastic member is a circular flat spring.
